(19) United States
(12) Patent Application Publication
(10) Pub. No.: US 2025/0209049 A1
(43) Pub. Date: Jun. 26, 2025

(54) METHOD AND SYSTEM FOR USING IMAGE ANALYSIS FOR TIME-SERIES FORECASTING

(71) Applicant: JPMorgan Chase Bank, N.A., New York, NY (US)

(72) Inventors: Zhen ZENG, Ypsilanti, MI (US); Rachneet KAUR, Manhattan, NY (US); Suchetha SIDDAGANGAPPA, Brooklyn, NY (US); Tucker Richard BALCH, Suwanee, GA (US); Manuela VELOSO, New York, NY (US)

(73) Assignee: JPMorgan Chase Bank, N.A., New York, NY (US)

(21) Appl. No.: 18/391,195

(22) Filed: Dec. 20, 2023

(51) Int. Cl. G06F 16/22; G06F 18/22

(52) U.S. Cl. CPC G06F 16/221; G06F 18/22

(57) ABSTRACT

A method for using image analysis for time-series forecasting is provided. The method includes: receiving numeric time-series data; converting the numeric time-series data into an image, wherein the image is a time-frequency spectrogram; analyzing the image by applying a vision transformer encoder to the image to learn multi-modal data across time and frequency; forecasting, based on the analyzing of the image, at least one future time-series data point. The method further includes converting of the numeric time-series data into the image by applying a wavelet transform for convoluting wavelets at different scales with the numeric time-series data to calculate a respective signal strength for each of the wavelets and outputting the calculated respective signal strengths as the time-frequency spectrogram.

### BACKGROUND

### 1. Field of the Disclosure

This technology generally relates to methods and systems for using image analysis for time-series forecasting, and more particularly to methods and systems for converting numeric time-series data into a time-frequency spectrogram to forecast future time-series data points.

### 2. Background Information

Time-series forecasting poses significant challenges due to the inherent noise in the data. Traditional statistical methods often utilize linear regression, exponential smoothing, and autoregression models. In recent years, deep learning has witnessed substantial progress, focusing on ensemble models and sequence-to-sequence modeling, such as recurrent neural networks (RNNs), long short-term memory (LSTM), and more recently, transformers. These advanced deep learning techniques offer enhanced capabilities in capturing complex non-linear dependencies within time-series data.

Time-series forecasting is a crucial task involving the statistical analysis of historical data to predict future values. In the literature, traditional forecasting techniques have relied on statistical tools like exponential smoothing and autoregressive integrated moving average (ARIMA), primarily applied to numerical time-series data for one-step-ahead predictions. Moreover, several traditional multi-horizon forecasting methods have been developed to generate simultaneous predictions for multiple future time steps.

Machine learning (ML) approaches have shown promise in improving forecasting performance by effectively addressing high-dimensional and non-linear feature interactions in a model-free manner. These ML methods encompass tree-based algorithms, ensemble methods, neural networks, autoregression, and recurrent neural networks (RNNs). In recent works, deep learning (DL) methods have gained traction in time-series forecasting, demonstrating impressive results on numerical time-series data. DL techniques automate the feature extraction process, eliminating the need for domain expertise and offering promising outcomes in forecasting tasks.

In the domain of natural language processing (NLP), RNNs, long short-term memory (LSTM), and gated recurrent units (GRUs) have been widely used for tasks like machine translation and language modeling. Interestingly, these models have been adapted for time-series forecasting, where they have outperformed traditional statistical methods. Furthermore, the DeepAR algorithm, utilizing the RNN backbone, has emerged as a potent approach in time-series forecasting. DeepAR has been more recently proposed and has shown superior performance compared to traditional forecasting techniques, particularly for datasets with multiple related time-series. This highlights the potential of RNN-based methods in handling complex time-series data and effectively capturing temporal dependencies.

Transformers, on the other hand, have revolutionized NLP applications and have also shown promise in time-series forecasting. Unlike traditional RNN and LSTM networks, transformers leverage multi-headed self-attention to process all inputs simultaneously. This parallel computation capability not only reduces training time but also enables transformers to handle longer sequences without suffering from long-term memory dependency issues, often encountered in RNN-based models. These characteristics make transformers well-suited for handling time-series forecasting tasks effectively. By effectively capturing complex temporal dependencies within time-series data, transformers have demonstrated their ability to outperform traditional methods and are gaining popularity as a powerful tool in the field of time-series forecasting.

In recent years, a novel approach has gained traction in time-series forecasting, which involves converting numeric data into images to leverage successful computer vision algorithms. This approach is motivated by the belief that visual representations of financial time-series, such as charts and graphs, can enhance traders' decision-making. Prior research has explored representing time-series data as images of line plots, recurrent plots, and candlestick plots for both forecasting and classification tasks. Furthermore, recent advancements in video prediction from the computer vision domain have been adapted to improve forecasting accuracy. These studies have bridged the gap between computer vision and time-series forecasting, offering innovative ways to capture and analyze temporal patterns in numerical data.

Given the inherent unpredictability in financial time-series, research has turned to decomposition techniques to reveal more detailed information at varying frequency levels. The wavelet transform's advantage over traditional time-series imaging methods lies in its ability to extract both local spectral and temporal information, resulting in a more comprehensive representation of the underlying data patterns. Prior research has already explored the utilization of time-frequency spectrograms for sign prediction in the finance domain. The application of time-frequency spectrograms is extended to time-series forecasting. Specifically, a multimodal image representation consisting of a time-frequency spectrogram augmented with intensities of numerical time-series data is utilized to capitalize on the advantages of this combined approach.

Moreover, transformers have been extended into the computer vision domain by integrating self-attention with convolutional neural network (CNN) architectures. It has been demonstrated that a pure transformer applied directly to sequences of image patches can achieve outstanding performance in image classification tasks. Recognizing this potential, a vision transformer for simultaneous learning in both the time and frequency domains, is utilized to capitalize on the spectrogram representation of the time-series data. The vision transformer's ability to handle cross-modality makes it well-suited for this task.

### SUMMARY

The present disclosure, through one or more of its various aspects, embodiments, and/or specific features or sub-components, provides, inter alia, various systems, servers, devices, methods, media, programs, and platforms for converting numeric time-series data into a time-frequency spectrogram to forecast future time-series data points.

According to an aspect of the present disclosure, a method for using image analysis for time-series forecasting is provided. The method is implemented by at least one processor. The method includes: receiving, by the at least one processor, numeric time-series data; converting, by the at least one processor, the numeric time-series data into an image, wherein the image is a time-frequency spectrogram; analyzing, by the at least one processor, the image by applying a vision transformer encoder to the image to learn multi-modal data across time and frequency; and forecasting, by the at least one processor based on the analyzing of the image, at least one future time-series data point.

The converting of the numeric time-series data into the image may include applying a wavelet transform for convoluting wavelets at different scales with the numeric time-series data to calculate a respective signal strength for each of the wavelets and outputting the calculated respective signal strengths as the time-frequency spectrogram.

The time-frequency spectrogram may be augmented to include an image stripe row at a top of the time-frequency spectrogram, the image stripe row comprises a normalized time-series of the numeric time-series data, which includes sign information that relates to the calculated signal strengths.

The time-frequency spectrogram may include rows and columns, the rows corresponding to varying wavelet frequencies and the columns corresponding to time.

The analyzing may further include processing the image by appending a multi-layer perceptron (MLP) component to the vision transformer encoder and dividing the image into non-overlapping patches of equal size to generate image-patch-sized time intervals in a horizontal time axis, converting the patches to tokens by linear projection, and adding one-dimensional position embedding to the tokens to generate latent feature vectors.

The applying of the vision transformer encoder to the image may further include learning temporal dependencies between time and frequency patterns across a horizontal time axis of the image.

The method may further include converting each row of the time-frequency spectrogram to an image row with intensities represented as integers within a predetermined range.

The numeric time-series data may include daily prices for at least one financial instrument over a predetermined period of time, and a result of the forecasting may include a forecasted price chart that relates to the at least one financial instrument.

The numeric time-series data may include temperature data over a predetermined period of time, and a result of the forecasting may include a forecasted temperature chart.

According to another aspect of the present disclosure, a computing apparatus for using image analysis for time-series forecasting is provided. The computing apparatus includes a processor; a memory; a display; and a communication interface coupled to each of the processor, the memory, and the display. The processor is configured to: receive, via the communication interface, numeric time-series data; convert the numeric time-series data into an image, wherein the image is a time-frequency spectrogram; analyze the image by applying a vision transformer encoder to the image to learn multi-modal data across time and frequency; and forecast, based on the analysis of the image, at least one future time-series data point.

The processor may be further configured to convert the numeric time-series data into the image by: applying a wavelet transform for convoluting wavelets at different scales with the numeric time-series data to calculate a respective signal strength for each of the wavelets; and outputting the calculated respective signal strengths as the time-frequency spectrogram.

The time-frequency spectrogram may be augmented to include an image stripe row at a top of the time-frequency spectrogram that relates to sign information, the image stripe row comprises a normalized time-series of the numeric time-series data, which includes sign information that relates to the calculated signal strengths.

The time-frequency spectrogram may include rows and columns, the rows corresponding to varying wavelet frequencies and the columns corresponding to time.

The processor may be further configured to analyze the image by appending a MLP component to the vision transformer encoder and dividing the image into non-overlapping patches of equal size to generate image-patch-sized time intervals in a horizontal time axis, converting the patches to tokens by linear projection, and adding one-dimensional position embedding to the tokens to generate latent feature vectors.

The processor may be further configured to apply the vision transformer encoder to the image by learning temporal dependencies between time and frequency patterns across a horizontal time axis of the image.

The processor may be further configured to convert each row of the time-frequency spectrogram to an image row with intensities represented as integers within a predetermined range.

The numeric time-series data includes daily prices for at least one financial instrument over a predetermined period of time, and a result of the forecasting includes a forecasted price chart that relates to the at least one financial instrument.

The numeric time-series data includes temperature data over a predetermined period of time, and a result of the forecasting includes a forecasted temperature chart.

According to yet another aspect of the present disclosure, a non-transitory computer readable storage medium storing instructions for using image analysis for time-series forecasting is provided. The storage medium includes executable code which, when executed by a processor, causes the processor to: receive numeric time-series data; convert the numeric time-series data into an image, wherein the image is a time-frequency spectrogram; analyze the image by applying a vision transformer encoder to the image to learn multi-modal data across time and frequency; and forecast, based on the analysis of the image, at least one future time-series data point.

The storage medium may be further configured to convert the numeric time-series data into the image by further causing the processor to: apply a wavelet transform for convoluting wavelets at different scales with the numeric time-series data to calculate a signal strength for each of the wavelets; and output the calculated signal strengths as the time-frequency spectrogram.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for converting numeric time-series data into a time-frequency spectrogram to forecast future time-series data points.

FIG. 4 is a flowchart of an exemplary process for implementing a method for converting numeric time-series data into a time-frequency spectrogram to forecast future time-series data points.

FIG. 5 is a flow diagram that illustrates a method for converting numeric time-series data into a time-frequency spectrogram to forecast future time-series data points.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

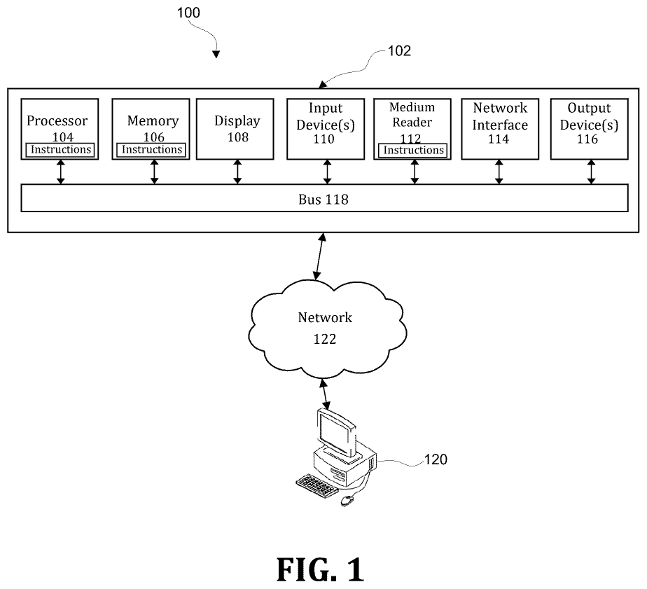

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for converting numeric time-series data into a time-frequency spectrogram to forecast future time-series data points.

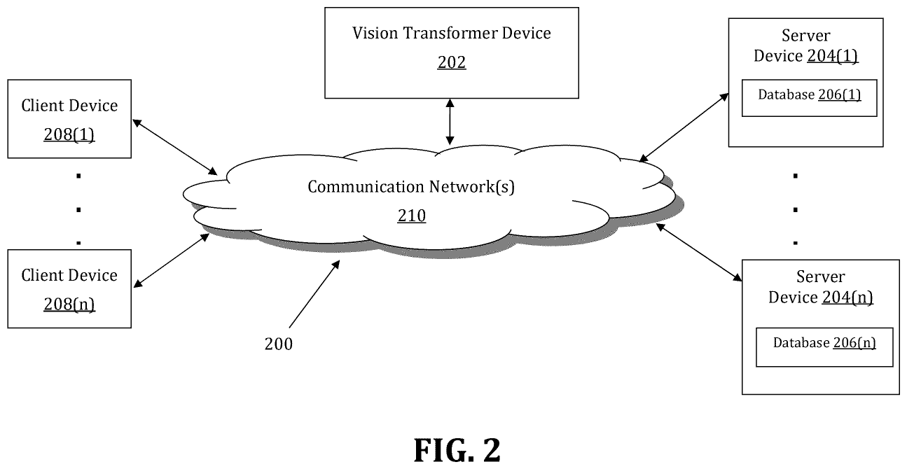

Referring to FIG. 2, a schematic of an exemplary network environment 200 for implementing a method for converting numeric time-series data into a time-frequency spectrogram to forecast future time-series data points is illustrated. In an exemplary embodiment, the method is executable on any networked computer platform, such as, for example, a personal computer (PC).

The method for converting numeric time-series data into a time-frequency spectrogram to forecast future time-series data points may be implemented by a vision transformer device 202. The vision transformer device 202 may be the same or similar to the computer system 102 as described with respect to FIG. 1. The vision transformer device 202 may store one or more applications that can include executable instructions that, when executed by the vision transformer device 202, cause the vision transformer device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the vision transformer device 202 itself, may be located in virtual server(s) running in a cloud-based computing environment rather than being tied to one or more specific physical network computing devices. Also, the application(s) may be running in one or more virtual machines (VMs) executing on the vision transformer device 202. Additionally, in one or more embodiments of this technology, virtual machine(s) running on the vision transformer device 202 may be managed or supervised by a hypervisor.

In the network environment 200 of FIG. 2, the vision transformer device 202 is coupled to a plurality of server devices 204(1)-204(n) that hosts a plurality of databases 206(1)-206(n), and also to a plurality of client devices 208(1)-208(n) via communication network(s) 210. A communication interface of the vision transformer device 202, such as the network interface 114 of the computer system 102 of FIG. 1, operatively couples and communicates between the vision transformer device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the vision transformer device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and vision transformer devices that efficiently implement a method for converting numeric time-series data into a time-frequency spectrogram to forecast future time-series data points.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The vision transformer device 202 may be a standalone device or integrated with one or more other devices or apparatuses, such as one or more of the server devices 204(1)-204(n), for example. In one particular example, the vision transformer device 202 may include or be hosted by one of the server devices 204(1)-204(n), and other arrangements are also possible. Moreover, one or more of the devices of the vision transformer device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the vision transformer device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to a time-series data repository and a MLP component database.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the vision transformer device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the vision transformer device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the vision transformer device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the vision transformer device 202, the server devices 204(1)-204(n), or the client devices 208(1)-208(n), for example, may be configured to operate as virtual instances on the same physical machine. In other words, one or more of the vision transformer device 202, the server devices 204(1)-204(n), or the client devices 208(1)-208(n) may operate on the same physical device rather than as separate devices communicating through communication network(s) 210. Additionally, there may be more or fewer vision transformer devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

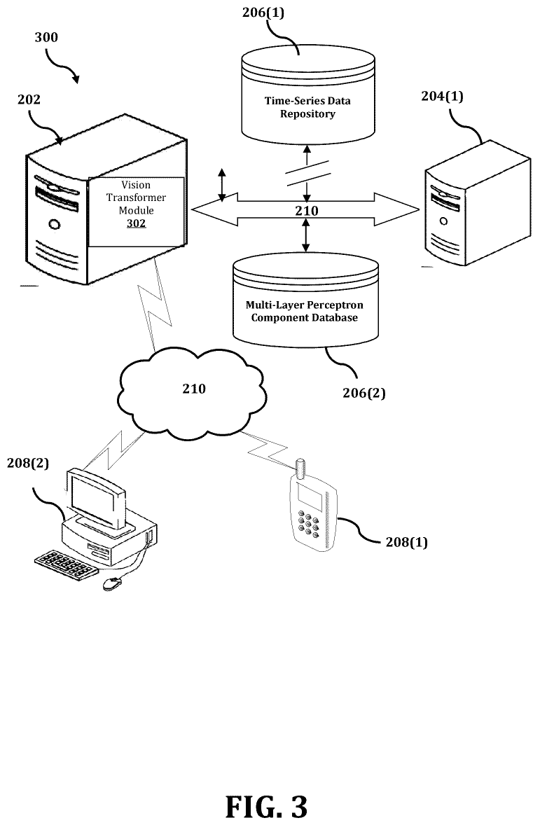

The vision transformer device 202 is described and illustrated in FIG. 3 as including a vision transformer module 302, although it may include other rules, policies, modules, databases, or applications, for example. As will be described below, the vision transformer module 302 is configured to implement a method for converting numeric time-series data into a time-frequency spectrogram to forecast future time-series data points.

An exemplary process 300 for converting numeric time-series data into a time-frequency spectrogram to forecast future time-series data points by utilizing the network environment of FIG. 2 is illustrated as being executed in FIG. 3. Specifically, a first client device 208(1) and a second client device 208(2) are illustrated as being in communication with the vision transformer device 202. In this regard, the first client device 208(1) and the second client device 208(2) may be “clients” of the vision transformer device 202 and are described herein as such. Nevertheless, it is to be known and understood that the first client device 208(1) and/or the second client device 208(2) need not necessarily be “clients” of the vision transformer device 202, or any entity described in association therewith herein. Any additional or alternative relationship may exist between either or both of the first client device 208(1) and the second client device 208(2) and the vision transformer device 202, or no relationship may exist.

Further, vision transformer device 202 is illustrated as being able to access a time-series data repository 206(1) and a MLP component database 206(2). The vision transformer module 302 may be configured to access these databases for converting numeric time-series data into a time-frequency spectrogram to forecast future time-series data points.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the vision transformer device 202 via broadband or cellular communication. Of course, these embodiments are merely exemplary and are not limiting or exhaustive.

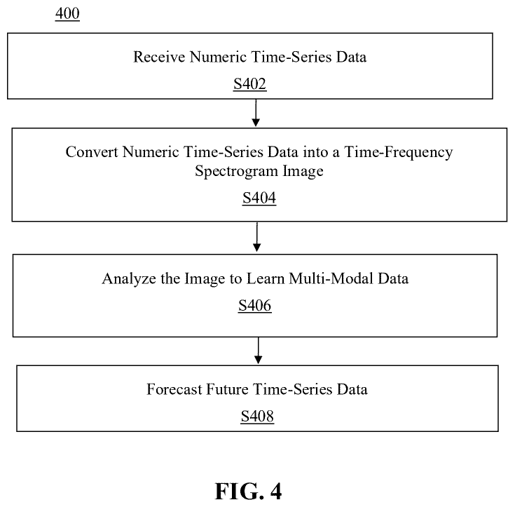

Upon being started, the vision transformer module 302 executes a process for converting numeric time-series data into a time-frequency spectrogram to forecast future time-series data points. An exemplary process for converting numeric time-series data into a time-frequency spectrogram to forecast future time-series data points is generally indicated at flowchart 400 in FIG. 4.

In process 400 of FIG. 4, at step S402, the vision transformer module 302 receives numeric time-series data. In an exemplary embodiment, the numeric time-series data may include a diverse range of datasets from different domains. For example, the datasets may include synthetic time-series data, temperature data, and/or financial time-series data.

At step S404, the vision transformer module 302 converts the numeric time-series data into an image. In an exemplary embodiment, the image is a time-frequency spectrogram. In an exemplary embodiment, converting the numeric time-series data into the image may include applying a wavelet transform for convoluting wavelets at different scales with the numeric time-series data to determine a signal strength for each of the wavelets. The vision transformer module 302 may then output the calculated signal strengths as the time-frequency spectrogram. In an exemplary embodiment, the time-frequency spectrogram is augmented to include an image stripe row at a top of the time-frequency spectrogram where the image stripe row includes a normalized time-series of the numeric time-series data, which includes sign information that relates to the calculated signal strengths.

In an exemplary embodiment, the time-frequency spectrogram may include rows and columns. The rows may correspond to varying wavelet frequencies and the columns may correspond to time. In an exemplary embodiment, each row of the time-frequency spectrogram may be converted to an image row with intensities represented as integers within a predetermined range.

At step S406, the vision transformer module 302 analyzes the image to learn multi-modal data. In an exemplary embodiment, the analysis is performed by applying a vision transformer encoder to the image. The multi-modal data may include time and frequency domains. In an exemplary embodiment, analyzing the image includes processing the image by using a vision transformer encoder with an appended MLP component and dividing the image into non-overlapping patches of equal size to generate image-patch-sized time intervals in a horizontal time axis. The vision transformer encoder with the MLP then converts the patches to tokens by linear projection and adds one-dimensional position embedding to the tokens to generate latent feature vectors. In an exemplary embodiment, the vision transformer encoder is applied to the image to learn temporal dependencies between time and frequency patterns across a horizontal time axis of the image.

Then, at step S408, the vision transformer module 302 forecasts time-series data for a period of time in the future. In an exemplary embodiment, the numeric time-series data includes daily prices for at least one financial instrument over a predetermined period of time, and a result of the forecasting includes a forecasted price chart that relates to the at least one financial instrument. In another exemplary embodiment, the numeric time-series data includes temperature data over a predetermined period of time, and the result of the forecasting includes a forecasted temperature chart.

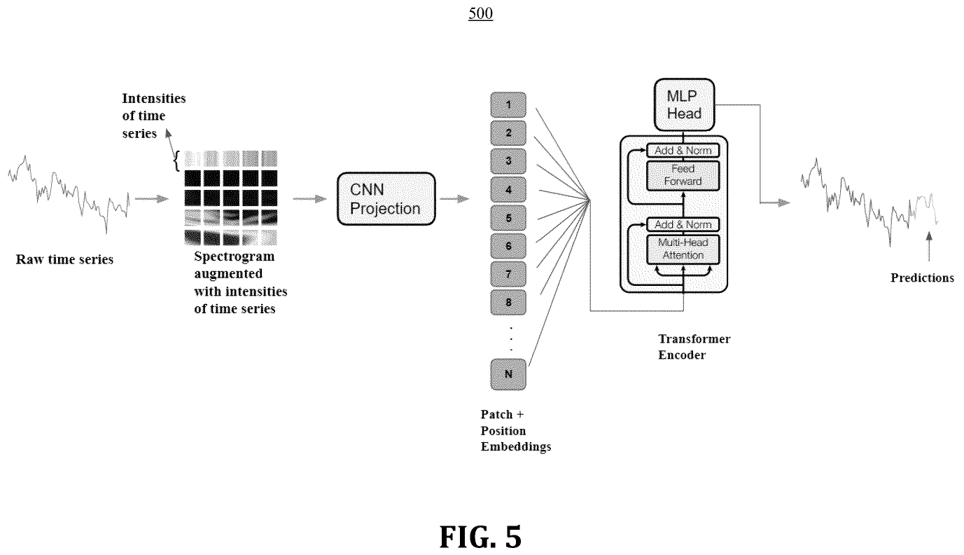

FIG. 5 is a flow diagram 500 that illustrates a method for converting numeric time-series data into a time-frequency spectrogram to forecast future time-series data points. In an exemplary embodiment, as illustrated in FIG. 5, raw time-series data is converted to a spectrogram augmented with intensities of the time-series that is divided into non-overlapping patches of equal size. The patches are then converted to tokens through linear projection using a CNN projection architecture and standard one-dimensional position embedding is added. The patches are then sent to the vision transformer encoder with an appended MLP head, which analyzes the data and outputs a predicted chart of future time-series data.

In recent years, a new perspective has been introduced for forecasting time-series where numeric data is converted to images to leverage successful computer vision algorithms for forecasting. These studies are motivated by the fact that traders' decision making is augmented by the visual representation of financial time-series images such as charts, graphs, and plots. In addition, this approach can help to capture additional patterns and dependencies that are beneficial for understanding and forecasting time-series data. However, these approaches typically use lineplots as the visual representation of time-series, which misses some crucial information required for understanding time-series. For example, frequency information is not apparent when directly looking at the time-series in its raw form.

One could use a frequency spectrum of a time-series as the visual representation. However, this merely displays the various frequency components present in the data. High-frequency components are often associated with noise, while low-frequency components correspond to signals. However, it does not provide insights into the temporal dependencies between occurrences of different frequency components. Conversely, the time-frequency spectrogram visually represents how the frequency spectrum changes over time, enabling the learning of temporal dependencies between different frequency patterns.

In an exemplary embodiment, the vision transformer module 302 uses time-frequency spectrograms as visual representations of time-series data and leverages vision transformers to achieve simultaneous learning in both the time and frequency domains, enabling accurate forecasting.

The vision transformer module 302 presents the following key contributions: the superiority of spectrograms as a visual representation of time-series data, leading to enhanced predictions across various domains and diverse datasets; and the ability to learn cross-modality information across time and frequency domains to enhance the forecasting process.

The vision transformer module 302 has advantages and is effective on diverse datasets from different domains, including synthetic time-series data, temperature data, and financial time-series data.

In an exemplary embodiment, the vision transformer module 302 may be applied to three datasets, out of which one is synthetic and the other two are real datasets, to comprehensively evaluate spectrogram-based forecasting techniques as they encompass varying levels of periodicity and complexity, thereby providing a comprehensive basis for the examination.

In an exemplary embodiment, the vision transformer module 302 is applied to a synthetic dataset consisting of multiple periods created by sampling data from harmonic functions. The initial dataset is artificially generated and aims to have complexity while still exhibiting a prominent and repeated signal. The time-series sₜ is synthesized using a linearly additive two-timescale harmonic generating function:

$${s}_{t} = ( {A}_{1} + {B}_{1} t ) sin ( 2 π t / {T}_{1} + {ϕ}_{1} ) + ( {A}_{2} + {B}_{2} t ) sin ( 2 π t / {T}_{2} + {ϕ}_{2} ) \qquad ( 1 )$$

In the equation, the variable t ranges from t=1 to t=T, where T represents the total length of the time-series. The multiplicative amplitudes A₁ and A₂ are randomly selected from a Gaussian distribution N(1, 0.5). The amplitudes of the linear trends, B₁ and B₂, are sampled from a uniform distribution U(−1/T, 1/T). The driving time scales, T₁ and T₂, are relatively short and long compared to the total length T. Therefore, T₁ follows a normal distribution N(T/5, T/10), while T₂ follows a normal distribution N(T, T/2). Finally, the phase shifts ϕ₁ and ϕ₂ are chosen from a uniform distribution U(0, 2π). Overall, a number of time-series (e.g., 150,000) of a set length (e.g., 100) may be analyzed. Each time-series may differ concerning the possible combination of tuning parameters.

In an exemplary embodiment, the vision transformer module 302 is applied to a dataset containing various temperature observations gathered over a period of time. The dataset contains several attributes as equal length time-series (e.g., 725 days). The vision transformer module 302 may use the daily mean temperature (e.g., in Celsius) over a period of time (e.g., 24-hour period). The dataset may include a sampling of a number of time-series (e.g., 30) at a predetermined length (e.g., 60) for multiple locations to have an overall number of time-series (e.g., 7,320).

In an exemplary embodiment, the vision transformer module 302 is applied to daily stock prices of a variety of stocks through a database. The dataset comprises daily Adjusted Close values for the selected stocks, spanning from a predetermined year onwards. The dataset may include a total number of individual time-series (e.g., 58,000), with each time-series segment consisting of number of days of data (e.g., 100 days).

In an exemplary embodiment, the vision transformer module 302 uses a vision transformer and a multimodal image of time-frequency spectrogram augmented with intensities of numerical time-series. This approach leverages the strengths of both the visual representation from the spectrogram and the numerical information to improve forecasting performance. The approach involves converting the numeric time-series into an image using a time-frequency spectrogram, and then employing a vision transformer encoder appended with a MLP head to forecast the future, as illustrated in FIG. 5.

In an exemplary embodiment, missing values in the temperature dataset may be handled by performing forward filling, such that any missing values are replaced with the most recent available value in the dataset, moving forward in time. For each of the three datasets, data x was scaled to ensure that the scaled x fell within the range of [0, 1]. This scaled x was then utilized to incorporate the original time-series information into the spectrogram and to facilitate the learning of the target.

To generate a time-frequency spectrogram from a given time-series, two common methods are Short-Time Fourier transforms (STFT) and wavelet transforms. STFT involves a sliding window-based version of the Fourier transform and extracting frequency components within a fixed time window. However, it can only uncover a limited set of frequency components within this fixed window and may not be suitable for non-periodic and transient signals in stock price time-series. Conversely, wavelet transform is well-suited for analyzing time-series with transient signals, as it can uncover varying frequency components. Unlike STFT, wavelet transform is not limited by a fixed time window, making it a more suitable choice. Therefore, wavelet transforms are chosen for generating time-frequency spectrograms from time-series data.

A wavelet is a wave-like oscillation (zero-mean signal) that is localized in both time and frequency space. In an exemplary embodiment, the vision transformer module 302 utilizes the morlet wavelet (see Equation (2) below), which is effective in time-series classification.

$$Ψ ( x ) = √ \frac{1}{s} {π}^{- \frac{1}{4}} {e}^{\frac{1}{2} \frac{x}{s}} {e}^{jw \frac{x}{s}} , \qquad ( 2 )$$

where s represents the scale of the wavelet. The morlet wavelet is essentially a sine wave multiplied by a Gaussian envelope centered at zero. The scale s determines the width and frequency of the wavelet. As s increases, the frequency of the wavelet becomes wider and lower. The wavelet transform is performed by convoluting wavelets at different scales with the time-series. The magnitude of the resulting multiplication coefficients represents the signal strength of different wavelets. This is saved as a heatmap (i.e., spectrogram). The rows of the spectrogram correspond to varying wavelet scales (i.e., varying frequencies). The columns correspond to time. Higher frequency components are at the top, and lower frequency components are at the bottom as the s increases from the top to the bottom.

Note the spectrogram is augmented by adding an image stripe row at the top, and the resulting full image was used as the input image to the model. The augmented image is referred to herein as the spectrogram. The reason for this augmentation is as follows: the standard spectrogram only visualizes the strength of varying signals, but it does not retain the sign of the signal, which is available in the time domain. To preserve the sign information, the standardized time-series is converted to an image row with intensities represented as integers in a range (e.g., [0, 255]).

In an exemplary embodiment, a vision transformer encoder with an appended MLP head is utilized for time-series forecasting, as illustrated in FIG. 5. To effectively process the input image, it is divided into non-overlapping patches of equal size. This division results in the horizontal time axis being split into image-patch-sized time intervals. These patches are then converted to tokens through linear projection, and standard one-dimension position embedding is added. The objective of the forecasting model is to learn temporal dependencies between time and frequency patterns across the horizontal time axis. The encoder learns to encode these patches into latent feature vectors. In exemplary embodiments, an input image size of 128×128, and image patches of size 16×16 may be used. The top row of the price time-series is scaled to 16×128, and the spectrogram is scaled to 112×128, ensuring that they are divisible by the patch size. The forecast network is constructed by appending a lightweight MLP head to the vision transformer encoder, as depicted in FIG. 5.

To evaluate the performance of the model, the forecasted prices may be initially transformed back to the original scale. The model produces continuous predictions, and the performance may be assessed using three metrics: Symmetric Mean Absolute Percentage Error (SMAPE), Mean Absolute Scaled Error (MASE), and sign accuracy.

1) SMAPE is defined as follows:

$$SMAPE = \frac{1}{T} {\sum }_{t = 1}^{T} \frac{\vert {x}_{t} - {\hat{x}}_{t} \vert}{( \vert {x}_{t} \vert + \vert {\hat{x}}_{t} \vert ) / 2} , \qquad ( 3 )$$

where T denotes the length of the predicted time-series (e.g., T=1, 2, 3, 4, 5); xt and \hat{x}ₜ is the observed ground truth and its corresponding forecast at time step t. SMAPE values lie within [0, 2], with smaller values implying a more accurate forecast.

2) MASE is defined as follows:

$$MASE = \frac{\frac{1}{T} {\sum }_{i = t}^{t + T} \vert {x}_{i} - {\hat{x}}_{i} \vert}{\frac{1}{t} {\sum }_{i = 1}^{t} \vert {x}_{i} - {x}_{i - 1} \vert} \qquad ( 4 )$$

MASE is the mean absolute error of the forecast divided by the mean absolute error of one-step forecast on the in-sample data. Note that MASE becomes unstable when the denominator approaches 0. Similar to SMAPE, lower MASE values indicate better forecasts.

3) Sign Accuracy: This represents the average classification accuracy across all test samples. A higher accuracy indicates more precise forecasts. Three classes are defined to classify forecast movements: class 1 for “going up”, class 2 for “remaining flat,” and class 3 for “going down”. To determine the class, the difference between the predicted forecasts and the last observed value in the input time-series are compared.

Accordingly, with this technology, an optimized process for converting numeric time-series data into a time-frequency spectrogram to forecast future time-series data points is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed:

1. A method for using image analysis for time-series forecasting, the method being implemented by at least one processor, the method comprising:
receiving, by the at least one processor, numeric time-series data;
converting, by the at least one processor, the numeric time-series data into an image, wherein the image is a time-frequency spectrogram;
analyzing, by the at least one processor, the image by applying a vision transformer encoder to the image to learn multi-modal data across time and frequency; and
forecasting, by the at least one processor based on the analyzing of the image, at least one future time-series data point.

2. The method of claim 1, wherein the converting of the numeric time-series data into the image comprises applying a wavelet transform for convoluting wavelets at different scales with the numeric time-series data to calculate a respective signal strength for each of the wavelets and outputting the calculated respective signal strengths as the time-frequency spectrogram.

3. The method of claim 2, wherein the time-frequency spectrogram is augmented to include an image stripe row at a top of the time-frequency spectrogram, the image stripe row comprises a normalized time-series of the numeric time-series data, which includes sign information that relates to the calculated signal strengths.

4. The method of claim 2, wherein the time-frequency spectrogram comprises rows and columns, the rows corresponding to varying wavelet frequencies and the columns corresponding to time.

5. The method of claim 1, wherein the analyzing further comprises processing the image by appending a multi-layer perceptron (MLP) component to the vision transformer encoder and dividing the image into non-overlapping patches of equal size to generate image-patch-sized time intervals in a horizontal time axis, converting the patches to tokens by linear projection, and adding one-dimensional position embedding to the tokens to generate latent feature vectors.

6. The method of claim 1, wherein the applying of the vision transformer encoder to the image further comprises learning temporal dependencies between time and frequency patterns across a horizontal time axis of the image.

7. The method of claim 1, further comprising converting each row of the time-frequency spectrogram to an image row with intensities represented as integers within a predetermined range.

8. The method of claim 1, wherein the numeric time-series data includes daily prices for at least one financial instrument over a predetermined period of time, and a result of the forecasting includes a forecasted price chart that relates to the at least one financial instrument.

9. The method of claim 1, wherein the numeric time-series data includes temperature data over a predetermined period of time, and a result of the forecasting includes a forecasted temperature chart.

10. A computing apparatus for using image analysis for time-series forecasting, the computing apparatus comprising:
a processor;
a memory; and
a communication interface coupled to each of the processor and the memory, wherein the processor is configured to:
receive, via the communication interface, numeric time-series data;
convert the numeric time-series data into an image, wherein the image is a time-frequency spectrogram;
analyze the image by applying a vision transformer encoder to the image to learn multi-modal data across time and frequency; and
forecast, based on the analysis of the image, at least one future time-series data point.

11. The computing apparatus of claim 10, wherein the processor is further configured to convert the numeric time-series data into the image by:
applying a wavelet transform for convoluting wavelets at different scales with the numeric time-series data to calculate a respective signal strength for each of the wavelets; and
outputting the calculated respective signal strengths as the time-frequency spectrogram.

12. The computing apparatus of claim 11, wherein the time-frequency spectrogram is augmented to include an image stripe row at a top of the time-frequency spectrogram, the image stripe row comprises a normalized time-series of the numeric time-series data, which includes sign information that relates to the calculated signal strengths.

13. The computing apparatus of claim 11, wherein the time-frequency spectrogram comprises rows and columns, the rows corresponding to varying wavelet frequencies and the columns corresponding to time.

14. The computing apparatus of claim 10, wherein the processor is further configured to analyze the image by appending a multi-layer perceptron (MLP) component to the vision transformer encoder and dividing the image into non-overlapping patches of equal size to generate image-patch-sized time intervals in a horizontal time axis, converting the patches to tokens by linear projection, and adding one-dimensional position embedding to the tokens to generate latent feature vectors.

15. The computing apparatus of claim 10, wherein the processor is further configured to apply the vision transformer encoder to the image by learning temporal dependencies between time and frequency patterns across a horizontal time axis of the image.

16. The computing apparatus of claim 10, wherein the processor is further configured to convert each row of the time-frequency spectrogram to an image row with intensities represented as integers within a predetermined range.

17. The computing apparatus of claim 10, wherein the numeric time-series data includes daily prices for at least one financial instrument over a predetermined period of time, and a result of the forecasting includes a forecasted price chart that relates to the at least one financial instrument.

18. The computing apparatus of claim 10, wherein the numeric time-series data includes temperature data over a predetermined period of time, and a result of the forecasting includes a forecasted temperature chart.

19. A non-transitory computer readable storage medium storing instructions for using image analysis for time-series forecasting, the storage medium comprising executable code, which when executed by a processor, cause the processor to:
receive numeric time-series data;
convert the numeric time-series data into an image, wherein the image is a time-frequency spectrogram;
analyze the image by applying a vision transformer encoder to the image to learn multi-modal data across time and frequency; and
forecast, based on the analysis of the image, at least one future time-series data point.

20. The storage medium of claim 19, wherein to convert the numeric time-series data into the image, when executed by the processor, the executable code further causes the processor to:
apply a wavelet transform for convoluting wavelets at different scales with the numeric time-series data to calculate a respective signal strength for each of the wavelets; and
output the calculated respective signal strengths as the time-frequency spectrogram.
